(19) United States
(12) Patent Application Publication
(10) Pub. No.: US 2011/0194917 A1
(43) Pub. Date: Aug. 11, 2011

(54) Storage Rack

(75) Inventor: Alexander MIKSCH, Goppingen (DE)

(73) Assignee: Miksch GmbH, Goppingen (DE)

(21) Appl. No.: 13/023,436

(22) Filed: Feb. 8, 2011

(30) Foreign Application Priority Data
Feb. 9, 2010 (DE) 10 2010 001 724.8

(51) Int. Cl. B25H 3/04

(52) U.S. Cl. 414/222.07; 414/331.01

(57) ABSTRACT

A storage rack for storing and transferring objects is provided with at least one rack module (1) including a plurality of shelves (1a), wherein a laterally insertable receiving means (2) is assignable to each shelf (1a), and wherein each receiving means (2) comprises at least one object receiver for a safe arrangement of an object (W); a lifting unit (4) for receiving a receiving means (2) removed from a shelf (1a) of the rack module (1), and for vertically displacing the receiving means (2); and a transfer unit (3) for receipt/delivery of the object (W) from/to the receiving means (2), and for further handling of the object (W).

### FIELD OF THE INVENTION

The present invention relates to a storage rack.

Various storage racks are known in the state of the art. Storage racks are intended to be capable of receiving and keeping available an as large variety of tools or similar objects as possible in large quantities so that they can be removed from the storage rack when needed and can be appropriately applied.

Therefore, a storage rack must be capable of receiving, on the one hand, a lot of sometimes very different tools or corresponding objects and, on the other hand, of making them available to the person requiring them as quickly as possible. In the state of the art loading the storage rack with tools/objects and removing the latter from the same has been solved in various ways. It is a problem in the state of the art in this context that due to the different sizes and shapes of the tools/objects the loading means/removing means have to be designed such that they can correspond to the handling of the different sizes/shapes. Therefore, in order to have high flexibility as regards the handling of an as large number of sizes/shapes as possible, a corresponding space requirement is necessary for the charging means/removing means.

It is the object of the present invention to permit the space requirement when charging/removing tools/objects to/from a storage rack.

This object is achieved by a storage rack comprising the features of claim 1.

Advantageous further developments of the present invention are illustrated in the dependent claims.

In a storage rack comprising the features of claim 1 small space requirement is ensured for the total system.

In a storage rack comprising the features of claim 2 a tool/object is safely supported on the receiving means. Moreover, receipt/hand-over is simple by way of the transfer unit.

A storage rack comprising the features of the claims 3 to 6, allows an optimum packing density for the tool handling.

In a storage rack comprising the features of claim 6 a technically simple and inexpensive shifting of the receiving means on the shelf is possible.

In a storage rack comprising the features of claim 7 an exact local relation between the lifting unit and the respective shelf is made possible, thus allowing rapid and accurate shifting of the receiving means.

In a storage rack comprising the features of claim 8 the transfer distances between the lifting unit and the respective shelf as well as between the lifting unit and the transfer unit are short, thus the space required for the total system being reduced even more.

In a storage rack comprising the features of the claims 9 and 10 the rack module can be extended in a simple way so that a large number of tools/objects can be employed by simple measures. Moreover, whole stack modules can be quickly exchanged. The tooling time is thus advantageously reduced.

The storage rack having the features of claim 11 ensures that selected objects for a work machine are quickly made available.

In a storage rack comprising the features of claim 12 it is possible to rapidly and directly transfer objects between the work machine and the transfer unit.

In a storage rack comprising the features of the claims 13 and 14 specific applications of the solution according to the invention are possible.

The present invention will be described hereinafter by way of attached drawings illustrating the invention by way of example.

### BRIEF DESCRIPTION OF THE DRAWINGS

FIG. 1 shows a schematic perspective view of a storage rack according to the present invention, wherein in FIG. 1 the gripping arm of a transfer unit grips a tool quiver provided in an intermediate storage.

FIG. 2 illustrates a top view of the storage rack according to FIG. 1.

FIG. 3 shows a schematic perspective view of the storage rack according to claim 1, wherein the gripping arm of the transfer unit grips a tool quiver containing a tool deposited on a receiving means.

FIG. 4 shows a schematic top view of the storage rack according to FIG. 3.

FIG. 5 illustrates a further schematic perspective view of the storage rack according to the invention.

### LIST OF REFERENCE NUMERALS

1 rack module

1a shelf

2 receiving means

3 transfer unit

4 lifting unit

11 electric forklift

12 lifting fork

31 gripping arm

32 tool quiver

33 intermediate storage

41 receiving table

50 work machine

W tool (object)

### DETAILED DESCRIPTION OF AN EMBODIMENT

Hereinafter an embodiment of the present invention is described by way of example.

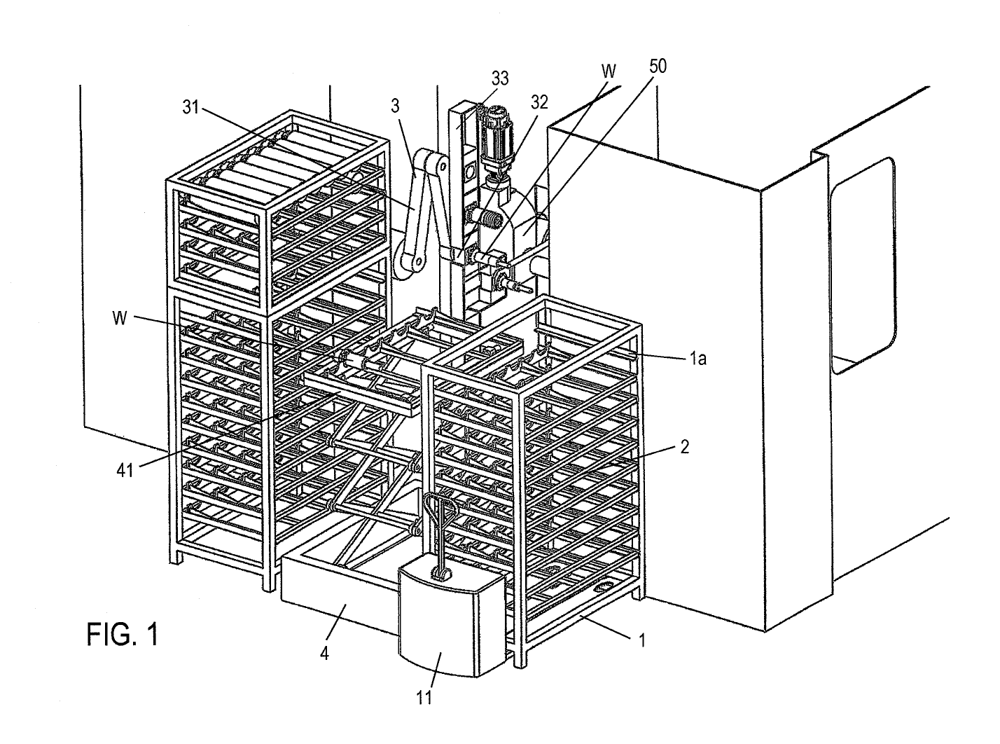

FIG. 1 shows a schematic perspective view of the storage rack according to the present invention, wherein in FIG. 1 the gripping arm of a transfer unit grips a tool quiver provided in an intermediate storage.

As one can take from FIG. 1, the storage rack of the present invention includes a movable rack module 1, a plurality of receiving means 2 for receiving tools, a transfer unit 3 to pass on the tools for the purpose of intermediate storage or use and a lifting unit 4.

The rack module 1 is designed in the form of a frame as a rack and includes shelves 1a in the form of simple L-shaped rails. Said L-shaped rails extend horizontally so that a receiving means 2 described below is adapted to slidably run along said rails in horizontal direction. In the rack module 1 the shelves 1a are arranged on top of each other, as can be taken from FIG. 1. In order to permit vertical shifting of the receiving means 2 on the shelf 1a, the L-shaped rails are arranged on the respective shelf 1a in parallel to each other as shown in the Figures so that the respective lower legs of the L-shape are facing each other. The vertical distance of the L-shaped rails and thus the shelves 1a in the rack module 1 from each other, i.e. the vertical height of each shelf, is selected in accordance with the tool to be stored in the rack module 1. That is, a relatively large tool requires a relatively large distance of the shelves 1a in the vertical direction, whereas a relatively small tool allows a relatively short distance in the vertical direction of the shelves 1a.

The rack module 1 is mobile and can be moved by means of a forklift 11 having an electric drive, for instance, illustrated in FIG. 1. The forklift 11 moves with its lifting forks 12 beneath the rack module 1 and lifts the rack module 1. In order to permit accurate placing of the rack module 1, appropriate positioning aids such as pins or guide plates can be provided at the bottom (they are not shown).

The rack module 1 according to the present invention can be extended so that on the upper side of the rack module 1 support means (not shown) are provided which permit stacking of another rack module 1 onto the rack module 1 so that plural rack modules 1 can be superposed. FIG. 1 shows on the right side a rack module 1 onto which no further rack module is stacked. On the left side of FIG. 1, on the other hand, a rack module 1 is shown on the upper side of which an additional rack module 1 is arranged. The superimposed rack modules (as, for instance on the left side of FIG. 1) are adapted to store similar or different tools and thus can have a vertical distance of the shelves 1a equal to each other or a different vertical distance of the shelves 1a. The respective lower rack modules 1 may have stands, whereas the rack modules 1 stacked onto the upper side of the lower rack modules 1 need not absolutely exhibit stands but may have appropriate integrating means which permit safe stacking. Even three or more rack modules 1 can be stacked on top of each other.

On the shelves 1 a respective receiving means 2 is arranged which serves for receiving tools W. In the embodiment of FIG. 1 on each shelf 1a a receiving means 2 is provided. Each receiving means 2 is movable in the horizontal direction relative to the associated shelf 1a along its L-shaped rails. Each receiving means 2 includes tool receiving constructions, wherein, depending on the size of the tool, a receiving means 2 may have one single tool receiving construction or a plurality of tool receiving constructions. In the case of especially large tools the receiving means 2 therefore includes merely one tool receiving construction, whereas in the case of tools having a smaller size a receiving means 2 of the present invention may include plural juxtaposed tool receiving constructions. In the example of FIG. 1 the receiving means 2 employed in the rack module 1 on the right side of the representation of FIG. 1 includes eight juxtaposed tool receiving constructions. The receiving means 2 exhibits a longitudinal extension in rectangular shape (as shown in FIG. 1) with two opposed cross braces of this rectangular shape (the front and the rear cross braces in FIG. 1) have running surfaces at their lower sides. Said running surfaces run on the L-shaped rails of the shelves 1a.

The tool receiving constructions of the respective receiving means 2 are formed in parallel to the afore-described running surfaces at the lower side of the receiving means 2. Especially each tool receiving construction has a groove shape. Said groove shape is adapted to the shape and the size of the respective tool to be deposited in the same. Therefore, in the present invention receiving means 2 having a long groove shape are possible for longer tools and those having a short groove shape are possible for shorter tools. Moreover, tool receiving constructions having a stepped form are applicable which permit safe storage of the respective tool deposited therein, wherein the contour of the respective tool is taken into account (when designing the tool receiving construction). When applying especially heavy tools, the receiving means can exhibit cross bracings in order to increase the stability.

A transport safety means is provided at the individual modules for preventing the receiving means 2 from slipping out during transport (due to tilting, lateral pulses etc.).

The present invention includes the lifting unit 4.

Said lifting unit 4 is preferably stationary and consists of a hinge structure having a receiving table 41 at the upper side of the lifting unit 4 and a drive. The drive ensures extending and withdrawing the receiving table 41 in vertical direction. The shape of the receiving table 41 at the upper side of the lifting unit 4 is adapted to receiving a receiving means 2. The lifting unit 4 is extended/withdrawn so that its receiving table 41 is aligned with respect to the corresponding receiving means 2 on the associated shelf 1a. The receiving table 41 of the lifting unit 4 therefore has a rectangular shape corresponding to the rectangular shape of the receiving means 2 in the present embodiment. The receiving table 41 of the lifting unit 4 includes at its upper side receiving surfaces designed so that respective running surfaces formed at the lower side of the receiving means 2 as described before are capable of running there.

Thus each receiving means 2 can be moved on the shelf 1a and on the running surfaces of the receiving table 41 of the lifting unit 4. Ideally the receiving means 2 is moved by a drive associated with the lifting unit 4. The drive can reasonably operate the modules on both sides of the lifting unit 4. In this way it is achieved that the individual rack modules can have a very simple design. In special cases it is also possible, however, that the drive is also associated with the module.

As an additional limitation the receiving table 41 of the lifting unit 4 includes limiting walls between which the receiving means 2 is allowed to move. To put it more exactly, the limiting walls of the receiving table 41 of the lifting unit extend adjacent to the upper running surfaces of the receiving table 41 at the outer side thereof (the front and rear sides in FIG. 1) so that a receiving means 2 moving horizontally on the upper running surfaces of the receiving table 41 runs between said limiting walls.

The lifting unit 4 can have various designs. In the present embodiment of FIG. 1 the lifting unit 4 makes use of the accordion effect by means of a hinge structure. Also other types of design can be chosen, as long as it is possible to extend and withdraw the receiving table 41 in the vertical direction and to stop the receiving table 41 at transfer positions aligned at the respective shelf 1a.

The present invention further comprises the transfer unit 3. The transfer unit 3 serves for removing a tool W provided on the receiving means 2 arranged at the upper side of the lifting unit 4 and depositing it at a storage position or for removing it from the storage position and depositing it on the receiving means 2. The transfer unit 3 of the present embodiment can be provided, for instance, with a tool changer as described in the patent DE 103 54 442. Such tool changer includes a tool depositing position at a vertically movable intermediate storage for a tool which is removed by a gripper gripping the tool and is transferred to a machine tool. The tool depositing position in the intermediate storage is in the form of a holder receiving a tool quiver (receiving pot) in which the tool is situated. The tool along with the tool quiver is received and transferred by the intermediate storage.

As described in the foregoing, the transfer unit 3 of the present embodiment can include the vertically movable intermediate storage 33 as depository as this is shown in FIG. 1. In said intermediate storage 33 receiving grooves for receiving a respective tool quiver 32 are provided. A tool quiver 32 is a tool receiving pot for receiving a tool W. Each tool quiver 32 has an internal shape such as, for instance, an internal cone corresponding to a conical shape formed at the tool. The tool in turn has the correspondingly shaped external cone by means of which it can be inserted into the machine tool (into a spindle or another counter piece).

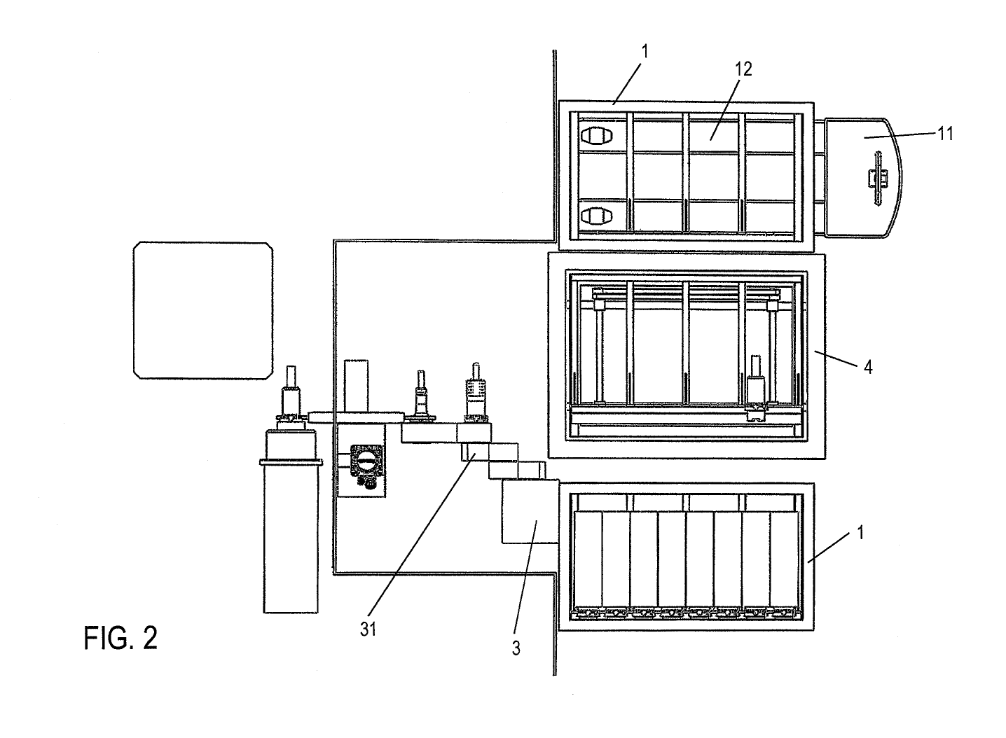

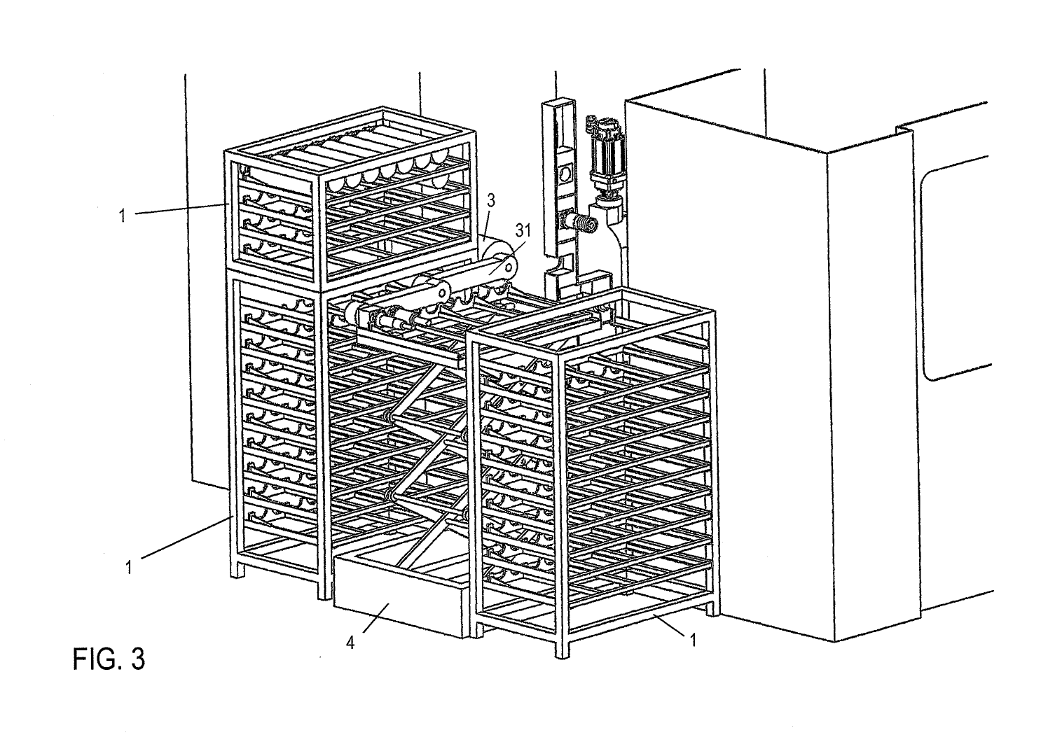

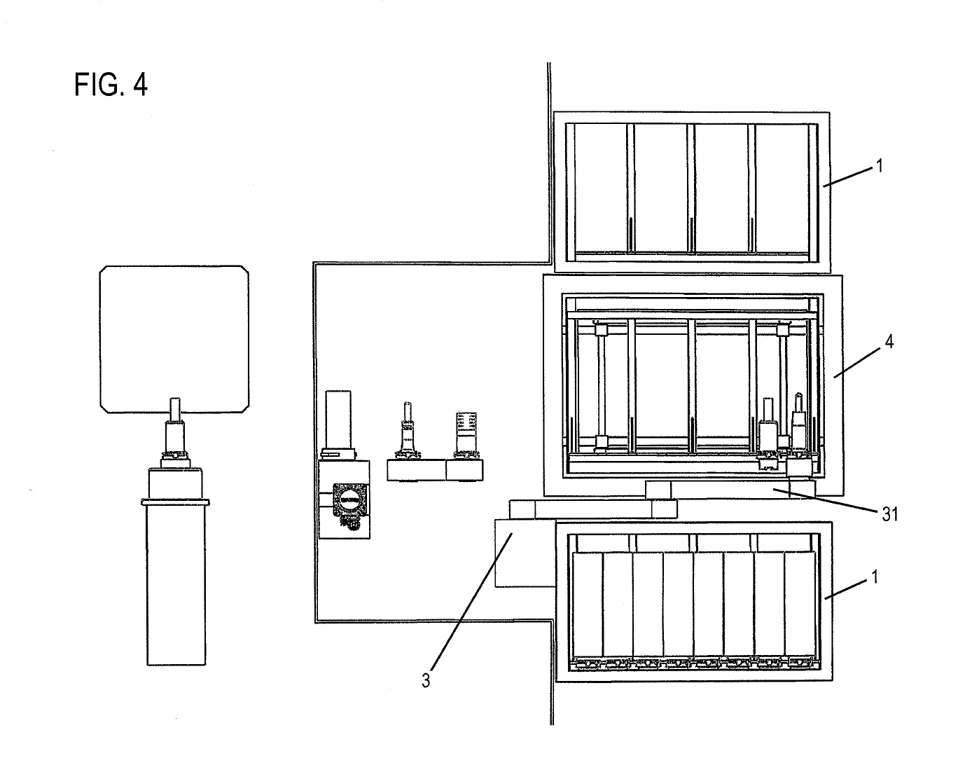

The transfer unit 3 includes a gripping arm 31. The gripping arm 31 is in the form of a hinge structure and is adapted to grip both the respective receiving groove of the intermediate storage 33 (cf. FIG. 1 and FIG. 2) and to the respective tools W on the receiving means 2 provided on the receiving table 41, when the receiving table 41 is disposed the vertical position permitting transfer from the receiving table 41 to the gripping arm 31. In the position in which it is maximally extended the gripping arm 31 can grip the tool W in the receiving formed part on the receiving table 41 which is most distant from the transfer unit 3, as represented in FIG. 3 and FIG. 4.

Therefore, the gripping arm 31 is adapted to grip a tool quiver 32 including the tool W provided in the same and to transfer both of them as a unit to the intermediate storage 33 and to deposit them there in the respective receiving groove.

Hereinafter the functioning mode of the present embodiment will be described.

1. Moving the Rack Module 1 to the Lifting Unit 4

The rack module 1 in which receiving means 2 that in turn store tools W are provided on the respective shelves 1a is shifted to the side of the lifting unit 4 such that when placing the rack module 1 the receiving means 2 can extend from the shelves 1a and can get onto the receiving table 41 of the lifting unit 4 when the receiving table 41 of the lifting unit 4 is moved at the appropriate height position of the shelf 1a in question.

2. Transfer of the Receiving Means 2 from the Rack Module 1 to the Lifting Unit 4

Then the lifting unit 4 extends or withdraws so that its receiving table 41 is aligned at the shelf 1a whose receiving means 2 is intended to transfer a tool W into the transfer unit 3. The running surfaces at the upper side of the receiving table 41 of the lifting unit 4 are aligned with respect to the running surfaces of the shelf 1a (L-shaped rails), i.e. they form corresponding extensions with respect to each other. Then the receiving means 2 is moved out of the shelf 1a to the receiving table 41 of the lifting unit 4, the receiving means 2 being guided through the limiting walls at the receiving table 41 of the lifting unit 4. When the receiving means 2 has reached the movement stopping position on the receiving table 41 of the lifting unit 4, its horizontal running movement is stopped.

3. Takeover of the Tool W from the Lifting Unit 4 by the Transfer Unit 3

Now the receiving table 41 of the lifting unit 4 is shifted to the transfer position at which the gripping arm 31 receives the tool W by means of the tool quiver 32.

When the receiving table 41 of the lifting unit 4 has reached its transfer position, the gripping arm 31 of the transfer unit 3 equipped with the tool quiver 32 is extended to the tool W which is intended to be removed from the receiving means 2, as shown in FIGS. 1 and 2. Then the tool quiver 32 disposed at the gripping arm 31 receives the tool W, for instance by a horizontal movement of the lifting unit in the longitudinal axis of the tool. Basically, for this movement also the same drive can be used as for extending the receiving means 2. If for subsequent operations an axial movement is required anyway, this movement could also be carried out by a component disposed downstream thereof (transfer unit, robot etc.).

After that the gripping arm 31 swivels to the intermediate storage 33 such that the tool quiver in which the received tool W is now accommodated is deposited in a receiving groove of the intermediate storage 33, as illustrated in FIGS. 3 and 4. The lifting means 4 can be lowered so that the movement of the gripping arm 31 is not hindered. Subsequently the tool W deposited in the intermediate storage 33 can be used by the work machine 50.

The afore-described course can also be carried out in the opposite manner, viz. from the intermediate storage 33 a tool can be removed by means of the gripping arm 31 and the tool quiver 32 and can be positioned on a receiving means 2 arranged on the receiving table 41 of the lifting unit 4.

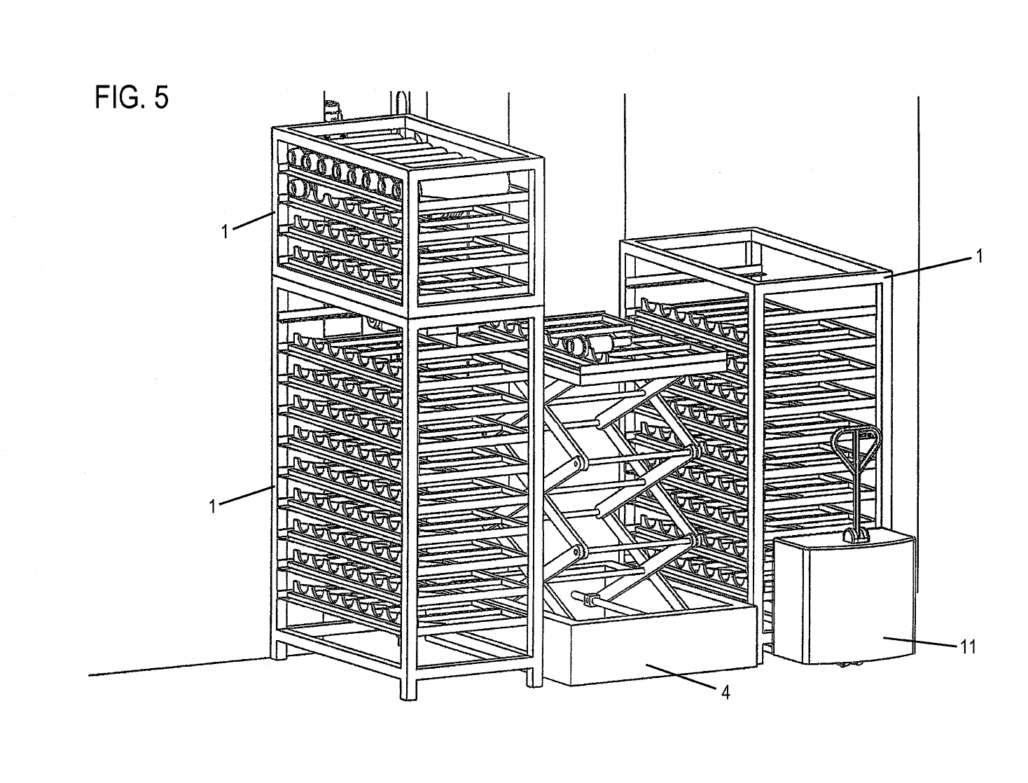

FIG. 5 shows another schematic perspective view of the storage rack according to the invention in which the working position of FIG. 1 and FIG. 2 is represented under a different aspect so as to facilitate the comprehension of the invention.

The present invention illustrated by way of the afore-described embodiment offers plural advantages.

By way of the present invention an optimum packing density is achieved for a storage rack by appropriately designing the rack modules.

The space required for the tool handling is small.

The storage rack can be easily extended by a second storage position for another mobile rack module and/or by stacking of the rack modules on top of each other.

By exchanging entire rack modules easy and quick tooling can be achieved.

It is possible to make multiple uses of existing feed motions (e.g. the tool quiver can be put onto and removed from the tool cone by the existing shaft drive of the lifting unit).

A simple design of the rack modules is possible due to small requirements to tolerance and lacking inherent shaft drives.

### MODIFICATIONS OF THE EMBODIMENT

The embodiment described in the foregoing by way of the drawings merely exemplifies the idea of the present invention. The present invention is not solely restricted to the embodiment. For instance, the present invention can be modified as follows.

In the afore-described embodiment the rack module 1 is mobile. The invention is also applicable to the case in which at least one rack module is fixed. Moreover, theoretically the entire principle is also possible when rotated about 90° (according to the principle of an apothecary cabinet), wherein a plurality of juxtaposed shelves are provided in the rack module.

In the afore-described embodiment the rack module 1 is conveyed by an electric forklift 11. The forklift 11 can also be driven otherwise, as a matter of course. It is also imaginable, as an alternative, that the rack module 1 has its own drive and is provided with wheels. It is another possible alternative that the rack module 1 includes wheels and can be moved by means of an external drive (e.g. even manually). Preferably the wheels should then have a locking mechanism so as to avoid movement of the deposited rack module relative to the lifting unit.

In the afore-described embodiment the lifting unit is fixedly anchored on the floor. The lifting unit can also be anchored at the machine frame of the machine.

In the present embodiment the gripping arm of the transfer unit 3 transfers the tool W to an intermediate storage 33. As an alternative, the transfer unit 3 can also transfer a tool W directly to a tool changer. As another alternative, the transfer unit 3 can transfer a tool W also directly to a work machine 50.

In the present embodiment the tool receiving construction of the respective receiving means 2 has a groove shape adapted to the shape and the size of the respective tool to be deposited in the same. The receipt of the objects is not only restricted to the groove shape (gripping groove) but also there are also other possible options (flute-shaped deposit etc.). It is also imaginable that the receipt is carried out without any specific formed part so that e.g. a workpiece blank having plane surfaces is simply put onto the feed and is then collected by an appropriate gripping system possibly exhibiting additional movements in the gripping arm and is then transferred into the cutting machine either directly or via a buffer.

In the present embodiment the object stored, to be transferred and used by the work machine 50 is a tool W utilized in a machine tool 50. As an alternative, the object can be an electrode used in an eroding machine 50. Moreover, the object can be a workpiece. Further options of use are possible, for the principle underlying the present invention is not restricted to the type of object. Thus the invention is applicable to any appropriate objects to be stored, transferred and used at a site of use.

What is claimed is:

1. A storage rack for storing and transferring objects comprising:
at least one rack module including a plurality of shelves, wherein a laterally insertable receiving means is assignable to each shelf, and wherein each receiving means comprises at least one object receiver for a safe arrangement of an object;
a lifting unit for receiving a receiving means removed from a shelf of the rack module, and for vertically displacing the receiving means; and
a transfer unit for receipt/delivery of the object from/to the receiving means, and for further handling of the object.

2. A storage rack according to claim 1, wherein
each receiving means has an object receiver for each respective object, the object receiver being adapted to the shape of the object such that it is able to support the object laid upon the object receiver, and
the receiving means is adapted to be laterally inserted horizontally into the shelf.

3. A storage rack according to claim 2, wherein
at least one receiving means has plural object receivers juxtaposed in the shifting direction of the receiving means such that it can receive plural objects when they are adjacent to each other.

4. A storage rack according to claim 3, wherein
a size and a distance of the object receiver of the receiving means from each other are adapted to the respective object to be deposited so that as many objects as possible can be deposited in a row on the receiving means.

5. A storage rack according to claim 4, wherein
in the rack module the plurality of shelves are juxtaposed or vertically superimposed, and
the vertical height of each shelf is adaptable to the respective maximum size of the object stored on the receiving means assigned to said shelf.

6. A storage rack according to claim 5, wherein
each shelf includes rails on which the receiving means is movable.

7. A storage rack according to claim 6, wherein
the lifting unit vertically displaces the receiving means, is fixedly anchored on the floor or at the machine frame of a machine handling the objects and positioning aids for exactly positioning the mobile rack module are provided at the bottom next to the lifting unit.

8. A storage rack according to claim 7, wherein
the lifting unit includes a receiving table for receiving the receiving means in a horizontally extending rectangular shape having longitudinal sides opposed to which the rack module can be positioned and transverse sides, wherein the transfer unit is arranged in the area beyond a transverse side.

9. A storage rack according to claim 8, wherein
at both longitudinal sides rack modules can be positioned.

10. A storage rack according to claim 9, wherein
the rack module can be vertically extended such that at least one further rack module is adapted to be stacked onto the rack module.

11. A storage rack according to claim 10, wherein
the transfer unit is coupled to an intermediate storage in which the object can be stored before it is further handled.

12. A storage rack according to claim 10, wherein
the transfer unit is directly coupled to a work machine adapted to receive the object from the transfer unit, handle it and return it to the transfer unit.

13. A storage rack according to claim 12, wherein
the object is a tool used in a machine tool.

14. A storage rack according to claim 12, wherein
the object is an electrode used in an eroding machine.

15. A storage rack according to claim 12, wherein
the object is a workpiece.

16. A storage rack according to claim 15, wherein
the rack module is mobile or fix.
